(19) United States
(12) Patent Application Publication
(10) Pub. No.: US 2023/0368093 A1
(43) Pub. Date: Nov. 16, 2023

(54) SYSTEM AND METHOD FOR OPTIMIZING ENERGY PRODUCTION OF A SOLAR FARM

(71) Applicant: Vistra Zero LLC, Irving, TX (US)

(72) Inventor: Rachit Gupta, Westlake, TX (US)

(21) Appl. No.: 18/316,989

(22) Filed: May 12, 2023

Related U.S. Application Data
(60) Provisional application No. 63/341,776, filed on May 13, 2022.

(51) Int. Cl. G06Q 10/0631; G06Q 50/06

(52) U.S. Cl. CPC G06Q 10/06312; G06Q 50/06

(57) ABSTRACT

To optimize energy production of energy production sites, such as solar farms, there are a variety of maintenance and management factors that may be addressed to ensure optimal performance of energy production equipment on the energy production sites. Artificial intelligence may be employed to assist with identifying problems of energy production of common energy production equipment, physical properties, such as vegetation and/or energy production equipment, for example. The identified problems may be remediated, thereby reducing downtime and costs while optimizing energy production. As part of the analysis, in determining remediation of identified problems using artificial intelligence, predictive analyses of weather and other factors versus cost to perform certain remedial efforts may be performed.

### RELATED APPLICATIONS

This application claims priority to co-pending U.S. Provisional Application having Ser. No. 63/341,776 filed on May 13, 2022; the contents of which are hereby incorporated by reference in its entirety.

### BACKGROUND

Renewable energy comes in a variety of forms, generally including solar, wind, geothermal, hydropower, and biomass. Solar power accounts for about 5% (about 100 gigawatts (GW)) of total US electricity with a goal of 20% by 2050. Moreover, solar energy accounted for 46% of all new electricity-generating capacity in the US. Despite the significant increases in production and lowered cost of solar panels, renewable energy is under pressure from falling levelized cost of energy (LCOE), which describes the cost of power produced by solar over a period of time, and power purchase agreements (PPAs) that are used to sell solar power by owners or operators of solar farms to buyers of the solar power. As a result of LCOE and PPAs, pricing pressures are placed on the owners and operators of solar farms and other renewable energy production have a financial incentive to maximize electrical power being produced by the solar farms.

To maximize production from solar farms (i.e., sites on which solar panels and electrical equipment are located to produce and supply electricity to an electrical grid), maintenance of the power production site and solar power efficiency is of paramount importance. Percentages of efficiency ultimately defined profitability for owners and operators of solar sites. With the total amount of solar power being generated now and in the future, the ability to optimize energy production from solar farms is pivotal for future growth and productivity/profitability of the solar industry.

### BRIEF SUMMARY

To optimize energy production of energy production sites, such as solar farms, there are a variety of maintenance and management factors that may be addressed to ensure optimal performance of energy production equipment on the energy production sites. Artificial intelligence may be employed to assist with identifying problems of energy production of common energy production equipment, physical properties, such as vegetation and/or energy production equipment, for example. The identified problems may be remediated, thereby reducing downtime and costs while optimizing energy production. As part of the analysis, in determining remediation of identified problems using artificial intelligence, predictive analyses of weather and other factors versus cost to perform certain remedial efforts may be performed. For example, if soiling (e.g., dirt, dust, pollen, etc.) needs to be removed from a surface of solar panels and the cost would be a few thousand dollars, but there is rain prediction that is anticipated to clean the soul panels, a determination may be made to allow the rain to clean the solar panels rather than spending money for a cleaning crew. Other inspections, such as drones, may be used to capture images of the energy sites to provide visual or other spectral analyses to the owner or operator of the energy production site and that inspection information may be automatically analyzed as part of the analysis for determining when and how to commission remedial action at the energy production site.

One embodiment of a computer-implemented method of optimizing energy produced by an energy production site may include receiving, by at least one processor from an energy sensing system deployed at the energy production site, data indicative of real-time dynamic energy production of energy production equipment at the energy production site. A set of forecasts related to the energy produced by the energy production site including at least one of (i) power generation, (ii) market price, (iii) market demand, and (iv) useful life of the energy production equipment may be generated using a first artificial intelligence engine. Underperformance of the energy production site automatically may be determined by the processor(s) by performing at least one of (i) forecasting energy production, (ii) determining actual versus expected energy production, and (iii) monitoring a common piece of equipment across each of a plurality of parallel branches of common energy production equipment. In response to determining underperformance of the energy production site, an inspection system may be automatically selected from amongst multiple available inspection systems configured to (i) perform inspection of the energy production site and (ii) generate data captured at the energy production site. The data captured from the selected inspection system automatically may be analyzed by the processor(s) to produce inspection analysis data. A determination may be made by the processor(s) as to whether or not to perform a remedial action to increase energy production by the energy production equipment at the energy production site by executing an optimization engine that utilizes a function of the (i) set of forecasts, (ii) inspection analysis data, and (iii) one or more current and forecasted environmental factors at the energy production site. Based on results of the optimization engine, the remedial action may be deployed to be performed at the energy production site if a determination to perform remedial action is made.

An embodiment of a system for optimizing energy produced by an energy production site may include a non-transitory memory configured to store information associated with the energy production site, and at least one processor in communication with the non-transitory memory. The processor(s) configured to receive data indicative of real-time dynamic energy production of energy production equipment at the energy production site from at least one energy sensing device deployed at the energy production site A first artificial intelligence engine may be executed to generate a set of forecasts related to the energy produced by the energy production site, the set of forecasts including at least one of (i) power generation, (ii) market price, (iii) market demand, and (iv) useful life of the energy production equipment. Underperformance of the energy production site may be automatically determined by performing at least one of (i) forecasting energy production, (ii) determining actual versus expected energy production, and (iii) monitoring a common piece of equipment across each of a plurality of parallel branches of common energy production equipment. In response to determining underperformance of the energy production site, an inspection system may automatically be selected from amongst a plurality of available inspection systems configured to (i) perform inspection of the energy production site and (ii) generate data captured at the energy production site. The data captured from the selected inspection system received and stored in the non-transitory memory to produce inspection analysis data may be automatically analyzed. An optimization engine that utilizes a function of the (i) set of forecasts, (ii) inspection analysis data, and (iii) one or more current and forecasted environmental factors at the energy production site to produce optimization data indicative of resulting energy production by performing available remedial actions may be executed. A determination, based on the optimization data, as to whether or not to perform a remedial action to increase energy production by the energy production equipment at the energy production site may be made. Based on results of the optimization engine, the remedial action to be performed at the energy production site may be deployed if a determination to perform remedial action is made.

One embodiment of a computer-implemented method of optimizing energy produced by an energy production site may include receiving, by at least one processor from an energy sensing system deployed at the energy production site, data indicative of real-time dynamic energy production of energy production equipment at the energy production site. A set of forecasts related to the energy produced by the energy production site using a first artificial intelligence engine may be generated. A determination may be automatically determined by the processor(s) as to whether underperformance of the energy production site is occurring. In response to determining underperformance of the energy production site, an inspection system may be automatically selected from amongst a plurality of available inspection systems configured to (i) perform inspection of the energy production site and (ii) generate data captured at the energy production site. An automatic analysis may be performed by the processor(s) of the data captured from the selected inspection system to produce inspection analysis data. The processor(s) may determine whether or not to perform a remedial action to increase energy production by the energy production equipment at the energy production site by executing an optimization engine that utilizes a function of the (i) set of forecasts, (ii) inspection analysis data, and (iii) one or more current and forecasted environmental factors at the energy production site. Based on results of the optimization engine, the remedial action to be performed at the energy production site may be deployed if a determination to perform remedial action is made.

### BRIEF DESCRIPTION OF THE DRAWINGS

Illustrative embodiments of the present invention are described in detail below with reference to the attached drawing figures, which are incorporated by reference herein and wherein:

FIG. 1 is an image of an illustrative solar farm;

FIG. 2 is an image of a portion of a portion of a solar farm at an early hour in which shadows are cast over solar panels;

FIG. 3 is an illustration of an illustrative electrical system and structural configuration of a solar farm;

FIG. 4 is an illustration of an illustrative hierarchical schematic of electronics of a solar farm;

FIG. 5 is an illustration of an illustrative process for collecting information of a solar farm, analyzing the collected information using artificial intelligence, and performing remedial action(s) at the solar farm to optimize energy production from the solar farm;

FIG. 6 is an illustration of an illustrative architecture system for collecting information, analyzing the collected information using artificial intelligence, and remediating a solar farm;

FIG. 7 is an illustration of an illustrative high-level process for analyzing collected information from the solar farm; and

FIG. 8 is an illustration of an illustrative listing of energy data being monitored from inverters of a solar farm to show relative performance thereof.

### DETAILED DESCRIPTION

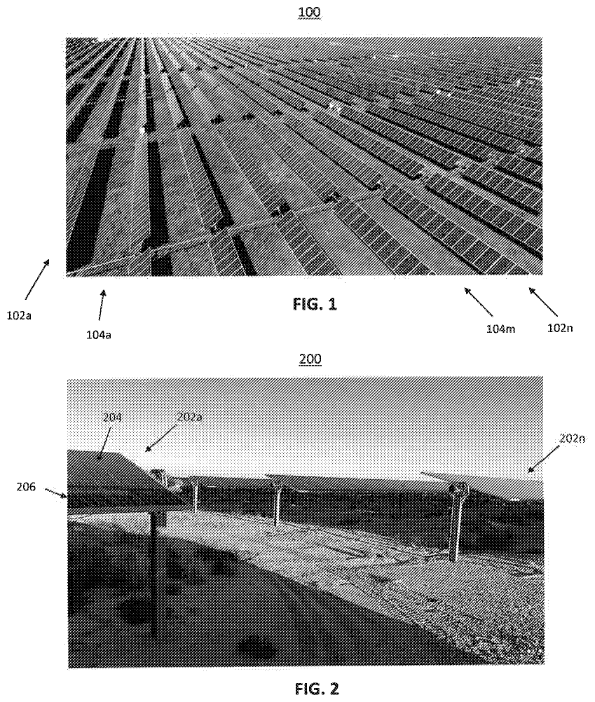

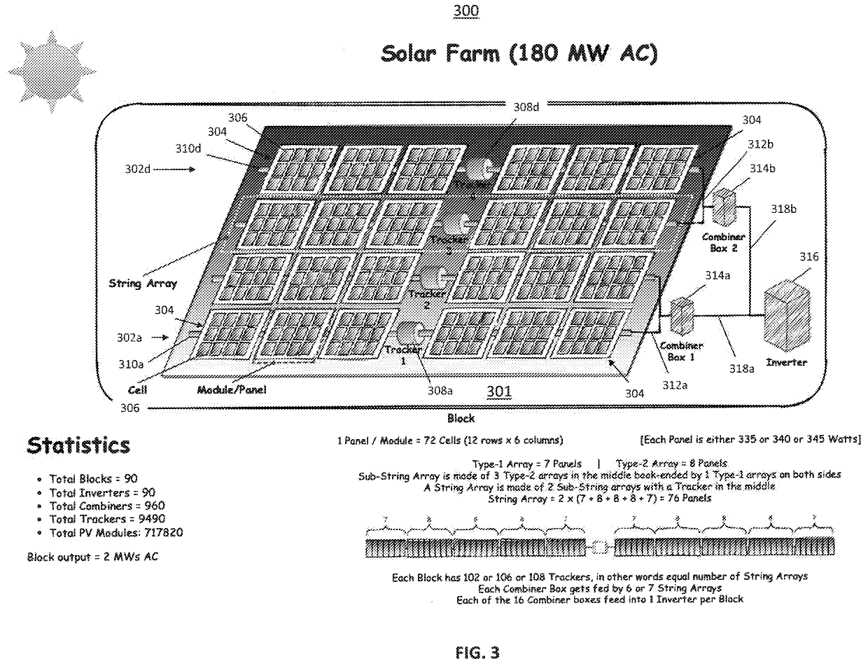

With regard to FIG. 1, an image of an illustrative solar farm 100 is shown. The solar farm 100 includes rows of solar panels 102a-102n (collectively 102) separated by rows of grasses and/or foliage (104a-104m). With the solar panels 102, there are a number of problems that may result in underperformance for generating electrical power. Such problems may include, but are not limited to, electrical equipment inefficiencies and/or failures, environmental factors, solar panel and solar cell structural problems, and so on. Electromechanical configurations of the rows of solar panels 102 are typically known as string arrays, as described with regard to FIG. 3 hereinbelow.

The electrical equipment may include (i) electrical combiners that combine the DC power generated by the solar panels, (ii) electrical inverters that convert direct current to alternating current (DC/AC), (iii) electromechanical trackers determine how/when to rotate the rows of solar panels 102 throughout the day to aim the solar panels 102 at the sun to maximize electrical energy production, and (iv) electrical controllers that control the rotation of the solar panels 102 in conjunction with the electromechanical trackers.

Environmental factors may include anything resulting from the environment in which the solar panels 102 are located that impacts the production of electrical power from the solar panels 102. Environmental factors may vary based on the specific location of the solar panels 102. Such environmental factors may include, but are not limited to, shadowing from foliage (e.g., trees, shrubs, tall grasses), and soiling (e.g., dust, dirt, and/or pollen) that settles on the solar panels 102.

Solar panel and solar cell structural problems may include problems that occur to the solar panels and structure of the solar panels. Such solar panel and solar cell structural problems may include, but are not limited to, delamination of the solar cells of the solar panels 102, hot spots on the solar cells, cracks of the solar panels 102, and solar string structural problems. As described further hereinbelow, any of the above-identified problems may cause reduction in electrical power production from the solar panels such that the electrical power is suboptimal.

With regard to FIG. 2, an image of a portion of a solar farm 200 inclusive of solar panels 202a-202n (collectively 202) at an early (or late) hour in which shadows are cast over at least a portion of the solar panels 202 is shown. As shown, a solar panel 202a includes a portion 204 of the solar panel 202a in which sunlight directly illuminates the solar panel 202a and a portion 206 of the solar panel 202a in which a shadow prevents sunlight from directly illuminating the solar panel 202a. As understood in the art, when a shadow impacts even a portion of a solar panel, the entire solar panel may not output electrical power to avoid an imbalance of electrical power on the electrical system with which the solar panel 202a communicates. Although the image of the solar farm 200 is representative of a time when one (or more) solar panels cast a shadow onto other solar panel(s), it should be understood that shadows may be cast from a variety of other local natural or manmade items, such as trees, shrubs, buildings, windmills, poles, vehicles, and a variety of other items that may cast shadows throughout a day and/or period of a year due to the location of the sun relative to the Earth.

With regard to FIG. 3, an illustration of an illustrative electrical system and structural configuration of a portion of a solar farm 300 is shown. The solar farm 300 may include a block 301 inclusive of string arrays 302a-302d (collectively 302) of respective solar panels or modules 304 inclusive of solar cells 306. It should be understood that the solar panels 304 may be identical or may have alternative configurations. Similarly, it should be understood that the solar cells 306 may be identical or have alternative configurations. Although only four string arrays 302 of solar panels 304 are shown, it should be understood that a significantly larger number of string arrays 302 may be utilized on the solar farm 300, as described hereinbelow. Each of the string arrays 302 may be rotated using one or more respective trackers 308a-308d (collectively 308), where the trackers 308 respectively rotate the string arrays 302 of solar panels 304 throughout a day based on orientation of the sun. The solar panels 304 may have additional electromechanical rotational devices and gimbal mechanisms that enable rotation of the solar panels 304 along axes of rotation other than the rotational axes of respective electrical conduit rails 310a-310d.

Electrical conductors 312a and 312b may extend within subsets of electrical conduit rails 310 to conduct DC electrical power from the solar panels 304 along the respective string arrays 302 of the rails 310, and may be electrically connected to combiners 314a and 314b to combine the DC electrical power being generated from multiple string arrays 302 of solar panels 304. The combiners 314 boxes may be electrically coupled with an inverter 316 via electrical conductors 318a and 318b. The inverter 316 converts the DC electrical power to AC electrical power for applying the AC electrical power to a power grid, as understood in the art.

In one embodiment, such as shown in FIG. 3, a solar farm that produces 180 megawatts (MW) may include 90 blocks of string arrays, 90 inverters, 960 combiners, 9490 trackers, and 717,820 photovoltaic modules. It should be understood that alternative configurations that result in different numbers of string arrays, inverters, combiners, trackers, and modules may be utilized. In an embodiment, each block 301 of the illustrative solar farm 300 may be capable of producing 2 MW AC power. Of course a number of factors, as previously described, may impact the theoretical or predicted production of power from each block. That is, with such large scales of electronics, mechanics, electro-mechanics, and materials used to form the solar farm, optimizing electrical power production from the solar farm can be a challenge, especially when maintenance and environmental factors are considered to achieve commercially viable levelized cost of energy (LCOE) given the nature of power purchase agreements (PPAs). As such, each aspect of the solar site may be monitored and remediated using artificial intelligence, as further described herein.

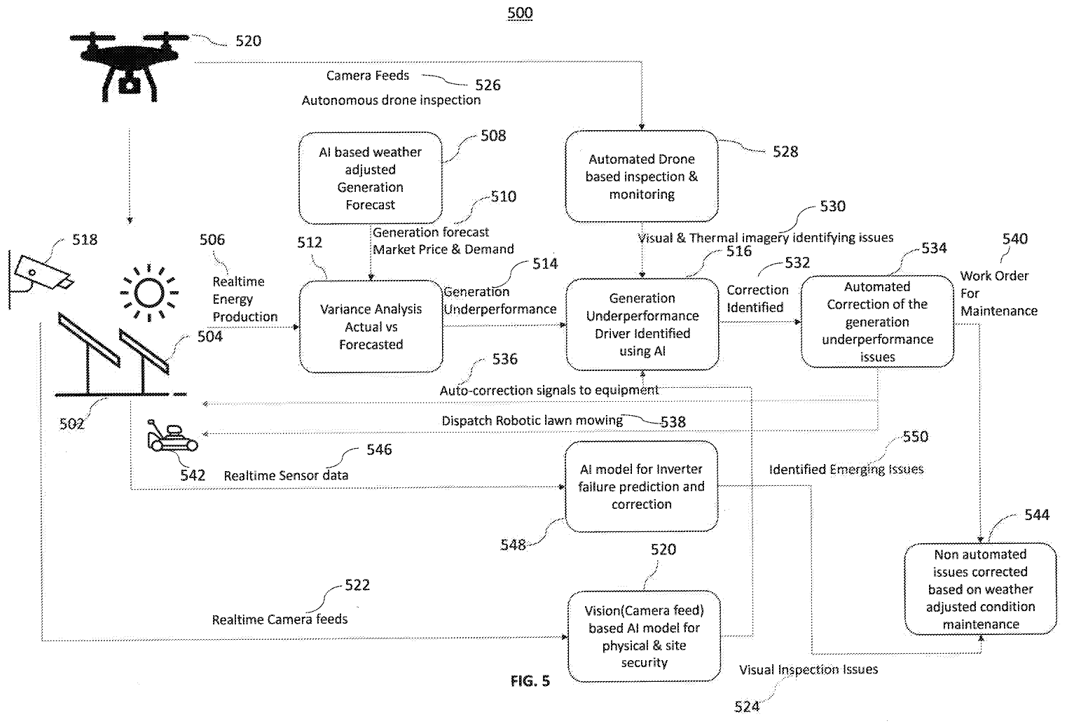

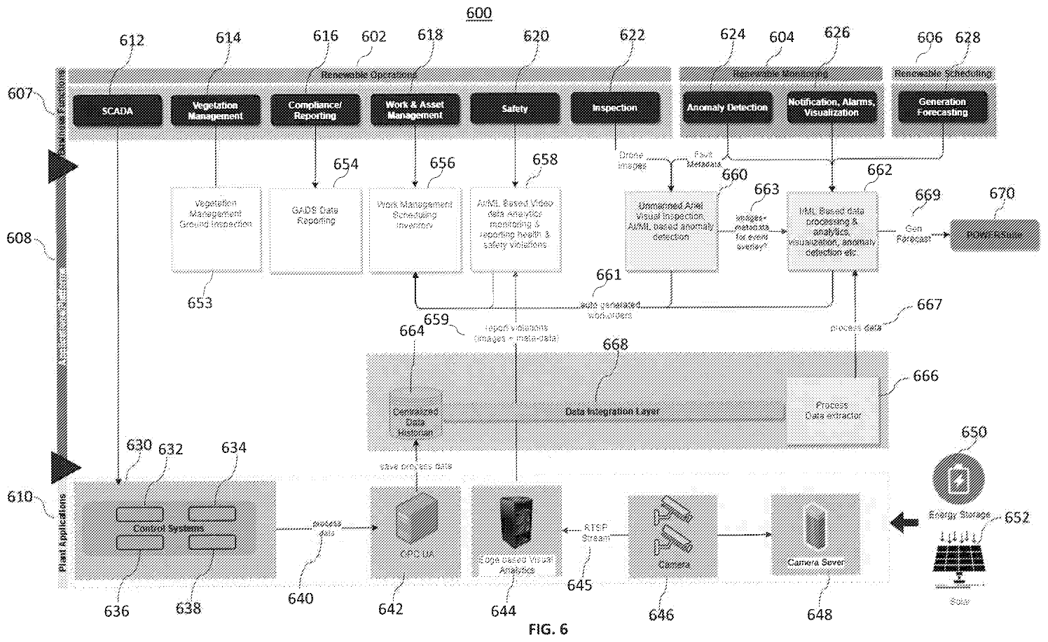

For a solar farm that is prescribed to produce 180 MW AC, each of the panels 304 may include 72 solar cells 306, which enables each of the panels 304 to produce 335 W, 340 W, or 345 W of DC power. There may be different types of arrays, which is a subset of the string arrays 302, where a type-1 array may include 7 solar panels 304 and a type-2 array may include 8 panels. A sub-string array may be configured with three type-2 arrays in the middle and book-ended by 1 type-1 arrays on both sides, such that a sub-string array includes 7 solar panels 304, 3×8 solar panels 304, 7 solar panels 304 (i.e., 38 solar panels 304 in total). Each of the string arrays 302 may thereby include 2 sub-string arrays to include a total of 76 solar panels 304, which results in 76×72=5,472 solar cells 306 for each of the string arrays 302. Based simply on the physical scale of a solar farm (e.g., ranging from 10+ to 100+ acres) and amount of mechanical, electrical, and electromechanical components to operate the solar farm, it is virtually impossible for individuals to be able to manually track all of the issues that may cause the solar farm or portions thereof to operate at sub-optimal levels. As a result, a system that incorporates a variety of different technological platforms bound by an integrated system that utilizes artificial intelligence is provided hereinbelow with regard to FIGS. 5 and 6, for example.

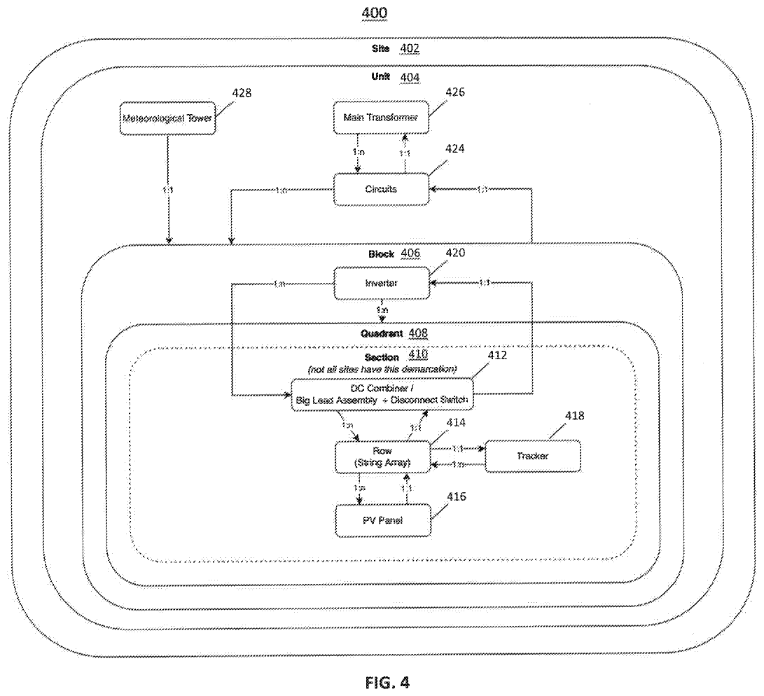

With regard to FIG. 4, an illustration of an illustrative hierarchical schematic of electronics of a solar farm 400 is shown. The solar farm 400 may include a site 402 on which a unit 404 is shown. The unit may be formed of blocks 406 defined by quadrants 408 and sections 410. Such a hierarchical configuration of a solar farm is typical, but it should be understood that alternative nomenclature and layouts may be utilized for different solar farms. In this particular embodiment, a section 410 may include a DC combiner 412, which often includes a big lead assembly and disconnect switch, that is in electrical communication with rows or string arrays 414 of solar panels 416, and each of the string arrays 414 may also include trackers 418 configured to rotate the string arrays 414 throughout a day, as previously described. Within the block 406, be an inverter 420 that is in electrical communication with the DC combiner 412 is utilized to generate AC power signals 422. The AC power signals 422 may be electrically communicated to circuits 424 that are configured to convert the AC power signals 422 for application to a main transformer 426 and onto a power grid (not shown). As previously described with regard to FIG. 3, the number of each of the components (e.g., string array 414, trackers 418, DC combiners 412, inverters 420, etc.) may be significant based on the size of the solar farm. A meteorological tower 428 may also be included within the unit 404 and be utilized for monitoring meteorological conditions at the solar farm 400. As will be described further herein, data collected by the meteorological tower 428 may be used for current and predictive analyses made by an artificial intelligence engine for determining when and/or how to remediate the solar farm 400.

With regard to FIG. 5, an illustration of an illustrative process 500 for collecting information of a solar farm 502, analyzing the collected information using artificial intelligence, and performing remedial action(s) at the solar farm 502 to optimize energy production from the solar farm 502 is shown. Although the process 500 is specifically configured to collect information and perform remedial action(s) at a solar farm, it should be understood that the same or analogous processes may be utilized to collect information and perform remedial action(s) at energy production locations that use alternative energy production technologies, such as geothermal, wave energy, wind turbines, biomass, nuclear, natural gas, and so on, utilizing artificial engines to assist in making remedial analyses and predictions.

The solar farm 502 inclusive of solar panels 504 may produce electrical energy 506, initially in the form of DC electrical energy and converted into AC electrical energy. In a parallel process executed by a computing system (see FIG. 6), an artificial intelligence (AI)-based weather-adjusted energy generation forecast process 508 may be configured to use artificial intelligence, such as a neural network, to forecast energy generation, market price, and demand data 510. In other words, an amount of energy that a solar farm is able to generate may be forecast as a function of weather information (e.g., rain predictions, cloud predictions, and so on) using artificial intelligence. In an embodiment, market intelligence and logistics functions may include the ability to perform energy generation forecasting, weather and market adjusted condition-based maintenance (e.g., allow rain to clean solar panels rather than paying humans to perform the cleaning service), and dynamic fulfillment and maintenance optimization.

A variance analysis of actual versus forecasted energy production process 512 may be executed by a computing system. The process 512 may receive both real-time energy production data 506 and energy generation forecast, market price, and demand data 510 as inputs and produce energy generation underperformance data 514. The energy generation underperformance data 514 may indicate that either the energy generation forecast is inaccurate or that the solar farm is underperforming the predictions. In the latter case where the solar farm is underperforming, that may indicate that a problem of the (i) solar equipment, such as one or more inverters, exists, (ii) environmental factor(s), such as (1) dirt or dust being on the solar panels or (2) foliage casting a shadow on one or more solar panels, (iii) or otherwise.

Because of the massive amount of equipment, land mass for a solar farm, and large (“big”) data collection, an artificial intelligence engine 516 may be used to process the various data sources. The data being collect may include imaging data of the solar farm 502 collected from fixed surveillance cameras 518 and/or drone(s) 520. The fixed surveillance cameras 518 may be used to continuously image solar panels in the field along with electrical equipment (e.g., inverters), as the fixed surveillance cameras 518 may be used to capture images and/or video to monitor the solar panels 504 for angles, dirt, foliage shadows, cracks, hotspots, etc. in the field, and used to capture images and/or video to monitor for fire (e.g., flame, thermal, and/or smoke detectors), tampering, etc. of the electrical equipment. The drone(s) 520 may be used to capture images and/or video of the solar panels 504 to monitor the solar panels 504 for angles, dirt, foliage shadows, cracks, hotspots, etc. The fixed surveillance cameras 518 may produce real-time camera feeds 522 and communicate those feeds 522 back to a vision-based AI model module 520 used to monitor for physical and site security. The module 520 may generate visual inspection issues data 524 that is to be processed by the energy generation underperformance driver using AI module 516. The drone(s) 520, which may be autonomous, may be configured to generate camera feeds 526, either real-time or non-real-time. An automated drone-based inspection and monitoring module 528 may be configured to generate visual and thermal imagery identifying issues data 530 that is to be processed by the energy generation underperformance driver using AI module 516.

The energy generation underperformance driver using AI module 516 may process the data 514, 524, and 530 to determine whether problems exist at the solar farm 502 and produce identify correction(s) data 532 to be made. An automated correction of the generation underperformance issues module 534 may be used to automatically and/or semi-automatically generate (i) auto-correction signals 536, (ii) dispatch robotic equipment signals 538, and/or (iii) generate work orders 540 for maintenance crews. The signals 536, 538, and 540 may be communicated to equipment, such as (3) cooling systems to automatically cool electrical equipment, (2) electromechanical rotational systems to rotate solar panels, (3) autonomous or automated lawnmowers or other equipment 542 that may reduce the height of grasses and/or foliage, (4) automated washing systems configured to wash solar panels (not shown), or otherwise.

Before dispatching the work orders 540, the module 534 may be configured to use AI predicted weather conditions to determine whether weather may be utilized to remediate the solar farm 502 naturally rather than having to spend money to dispatch autonomous/automated equipment or human workers. For example, if the solar panels 504 are dirty and need to be cleaned, then the module 534 may determine whether sufficient rain to “wash” the solar panels 504 is in the forecast in the next few days that would suffice in cleaning the solar panels 504. In an embodiment, the module 534 may use a cost analysis to compare an anticipated amount of energy that will not be produced due to the solar panels 504 being dirty prior to a predicted rain versus the cost for dispatching autonomous/automatic/humans to clean or otherwise make remedial actions at the solar panels 504 that are currently being impacted by the dirt on the solar panels 504. The work orders 540 may be communicated to workers and/or third-parties A non-automated process 544 may be performed at the solar farm 502 in response to receiving the work order(s) 540.

In addition to the work orders 540 being generated by the model 534, real-time sensor data 546 may be collected from sensors of electrical equipment (e.g., combiners, inverters, etc.) and/or electromechanical equipment (e.g., rotational motors for the solar panels 504). An AI model 548 may be used to predict electrical and/or electromechanical equipment failures and potential correction thereof and generate identified emerging issues data 550. The data 550 may be communicated for the non-automated process 544 to perform remedial actions at the solar farm 502 to avoid extensive problems that could have been avoided by performing routine maintenance in response to the AI model 548 predicting future failures.

An end-to-end solution, as generally described in FIG. 5, may be used to maximize the solar farm output, minimize downtime, reduce cost, and improve worker safety. A high-level illustrative end-to-end summary system process using the advanced artificial intelligence (AI) and machine language (ML) functionality as illustrated in FIG. 5 may be implemented to: (i) predict emerging issues, (ii) identify issues in real-time, and (iii) perform potential action to remediate an identified issue or address emerging issues are provided below:

Step 1. Create AI/ML based forecasts including, for example: (i) solar generation forecasts, (ii) Market Price, (iii) Market Demand, and (iv) Useful life of assets.

Step 2: Analyze underperformance may be based on three different methods: (i) energy generation forecast, (ii) solar irradiance, and (iii) best performing inverter.

Step 3: The under-performance can be based on different drivers, including (i) inverter(s)(DC/AC), DC side issues (e.g., combiners, tracker optimization, vegetation, soiling, PID losses, delamination, hot spot, cracks, shadowing, soiling, and string issues), (ii) anomaly detection in the end-to-end system.

Step 4: If an inverter is starting to have a problem or failure, the inverter AI/ML predictive model may predict potential emerging issues. Additionally, real-time model is optimizing the inverter efficiency from DC to AC conversion.

Step 5: If any issues are on the DC side (e.g., field devices, such as combiners, string arrays, and panels), AI models may be used to identify the issues prior to problems occurring.

Step 6: The AI/ML models may identify the potential issues-based tracker positioning/angles, combiner currents, and other factors on the real-time streamlining data. If the issues are with the tracker positioning, for example, in the morning, such as if the tracker angle is facing west, then the system may send a single to the control system automatically to correct the angle for yield optimization. As another example, if the combiner has lost a current and voltage feed to the inverter, then an autonomous drone may be used to fly visual and thermal imaging using AI/ML models in an attempt to identify any problems visually.

Step 7: Issues that cannot be identified using the real-time data stream alone may use autonomous drone capabilities with AI/ML models to identify panel/string issues, vegetation, soiling and tracker positioning, cracks, and delamination. Data generated by the AI/ML models may be automatically processed for automatic and/or manual remediation.

Step 8a: If the AI/ML model detects that an issue with the vegetation exists, then the system may send a signal to an autonomous robot (e.g., Renu Robot) to mow the area to perform vegetation control. The mowing robot also may include four cameras that may be used as ground inspection by generating streamlining ground-level data for additional visual analytics using the AI/ML model to identify any ground-based issues, including wire disconnections, animal damage, etc.

Step 8b: If the model detects shadowing on a solar panel, the AI/ML model may identify correct tracker angles to perform real-time updates for feedback to a control system that controls tracker angles.

Step 8c: If there are issues with panel/string, then an automated work order may be generated.

Step 8d: If soiling issues are identifying, an action for washes the solar panel(s) may be based on the forecasted weather (e.g., if there is a rainstorm in forecast, then factor that predicted forecast and skip requesting a truck washing crew to wash the solar panel(s)).

Step 9: The identified issues needing field action may be automatically send to an optimization model that takes weather and commercial market data, including parts, crew, and inventory, to schedule maintenance activities.

Step 10: The crew may arrive at the solar farm with a mobile laptop, HoloLens, and Blackline G7 device. The Blackline device is lone worker safety device provider worker safety including check-in and fall detection. If a worker fall is detected, then the autonomous drone may fly and provide real-time ground information. Any necessary actions to assist the work may be performed. The worker may also leverage a HoloLens to get expert assistance in real-time if an expert is needed for assistance by the worker.

The system may also use a fixed camera feed at the solar farm to identify any issues with site safety and other operational parameters for boosting energy production yield by the solar farm. In an embodiment, an application may provide reporting and data analytics capabilities for analyzing additional data in real-time. A predictive model may also use an AI/ML Natural language processing (NLP) to ingest data from a maintenance system to being a closed-loop system to capture physics data. Additionally, OEM manuals for combining physics and AI/ML algorithms for better and more accurate predictions.

TABLE I below provides for a summarization in chart format.

| Forecasting | Performance Measurement | Asset Health | Monitoring and Reporting | Maintenance |
|---|---|---|---|---|
| 1. Generation | 1. Underperformance | 1. Underperformance | 1. Centralized Dashboard | 1. Dynamic Fulfilment |
| 2. Price | 2. Variance Analysis | 2. Variance Analysis | 2. Decision between solar | & scheduling |
| 3. Demand | 3. DC side | 3. DC side | on grid vs storage | 2. Condition Based |
| 4. Weather | 4. AC side | 4. AC side | 3. Battery Charge/Discharge | Weather Adjusted |
| | 5. Soiling, Vegetation | 5. Soiling, Vegetation | based on Market dynamics | Maintenance |
| | 6. String/Panel Issues | 6. String/Panel Issues | 4. Construction Progress | 3. Integrate OEM |
| | 7. Tracker Optimization | 7. Tracker Optimization | Tracking | benchmarks |

With regard to FIG. 6, an illustration of an illustrative integrated energy production system 600 for collecting information, analyzing the collected information using artificial intelligence, and remediating a solar farm is shown. This integrated energy production system 600 is a more detailed view of FIG. 5 and the above-listed end-to-end summary system process. The system 600 may be categorized into a matrix-like structure defined by categories: renewable operations 602, renewable monitoring 604, and renewable scheduling 606 along the X-axis, and business functions 607, applications/platforms 608, and plant applications 610 along the Y-axis.

Within the renewable operations 602, a number of different business functions 607 may be defined and each of the business functions 607 may be supported by a process and system for performing tangible operations to support the solar farm. Those business functions 607 may include:
(i) renewable operations 602: (1) Supervisory Control and Data Acquisition (SCADA) 612, (2) vegetation management 614, (3) compliance/reporting 616, (4) work & asset management 618, (5) safety 620, and (6) inspection 622;
(ii) renewable monitoring 604: (1) anomaly detection 624 and (2) notification, alarms, visualization 626; and
(iii) renewable scheduling 606: energy generation forecasting 628.

SCADA 612 is generally considered to be a computer-based system for gathering and analyzing real-time data to monitor and control equipment that deals with critical and time-sensitive materials or events. In the system 600, the SCADA 612 may include one or more collection of systems 630, such as (a) visualization and control system 632 (e.g., GE Cimplicity software) that enables remote operators to manage operations at the solar farm, (b) command and control system 634 (e.g., Fractal EMS) to provide full command, control, monitoring, and management functionality for a single energy storage asset or fleet of assets, (c) automation system 636 (e.g., Emerson Ovation) that enables automation of certain assets, such as solar panels, and (d) storage management systems and management thereof that enables storage of energy during the day for delivery at night. Process data 640 produced by the systems 630 and communicated to a unified architecture 642 (e.g., OPC UA) that provide interoperability across an enterprise from machine-to-machine, machine-to-enterprise, and so on. The process data 640 may include real-time data produced by sensors (not shown) that collect energy production data, equipment operational data, and any other real-time data from the integrated energy production system 600. The unified architecture 642 provides for security amongst different platforms. The unified architecture 642 supports the work & asset management function 618 of the business functions 607.

Continuing along the plant applications 610, an AI image processing system 644 (e.g., Ensemble™ from SparkCognition) that processes real-time imaging data 645 data produced by fixed surveillance cameras 646 (e.g., Avigilon cameras). The AI image processing system 644 may be configured and/or trained to recognize a variety of different objects or otherwise (e.g., smoke, flames, foliage, people, animals, etc.) captured in images and/or video by the surveillance cameras 646 that are part of inspection 622 and/or anomaly detection 624 functions of the business functions 607. A camera server 648 may collect the streaming data 645 from the fixed surveillance cameras 646, as well, for storage and/or processing thereby. Energy storage systems (e.g., rechargeable batteries) 650 and solar panels 662 may be part of continuous monitoring by the fixed surveillance cameras 646.

In general, the AI image processing system 644 may be capable of providing the following, (i) underperformance identification (e.g., soiling, vegetation management, tracker optimization, string/panel outages and issues, and shadowing), (ii) predictive analytics (e.g., inverter analytics, anomalies detection), (iii) analyze functionality, (iv) dashboards, (v) reporting, (vi) video analytics, (vii) battery models, and (viii) original equipment of manufacture guide integration.

In the applications/platforms 608, a number of systems may be used to support the business functions 607. For example, for the vegetation management function 614, vegetation management and ground inspection platform 653 (e.g., RenuBots provided by Renu Robotics) may include robotic mowers and/or vegetation cutting systems that may be automatically deployed in the event that the fixed surveillance cameras 646 (or drones 520 of FIG. 5) capture shadows on the solar panels or other artifacts at the solar farm are identified by AI monitoring thereof. The compliance/reporting function 616 may be supported by a variety of systems, such as Archer. The compliance/reporting function 616 may be integrated with the Generating Availability Data System (GADS) utilized by the electric utility industry to maintain operating histories of power generation systems in North America.

The work & asset management function 618 may include a work management, scheduling, and inventory system 656 (e.g., Maximo by IBM). The safety function 620 may include an AI/ML-based video data analytics monitoring and reporting for health and safety violations. This system may utilize AI/ML algorithms to identify falls or other unanticipated human/machine or human/ground engagements, for example, that are captured by the fixed surveillance cameras 646 and identified by the AI image processing system 644 via report violations data 659 as images and/or metadata. The inspection function 622 and anomaly detection function 624 may be performed by unmanned aerial inspection system 660 inclusive of AI/ML-based anomaly detection processing. Drone images and fault metadata may be requested from the system 660, which may trigger the system 660 to automatically and autonomously capture information from the energy production site (e.g., solar farm) using aerial or other drones (e.g., land-based, subsea, sea-based, etc.). The AI/ML-based anomaly detection processing may be trained to detect shadows, cracks on solar panels, hotspots on solar panels, dirt or other debris on solar panels, animals within the solar farm, and so on. The system 660 may be provided by Percepto AIM, for example, and images collected and processed by the system 660 may be configured to auto-generate work orders 661 that are communicated to the work management scheduling inventory system 656. The system 660 may perform aerial inspection to identify panel and string issues, vegetation and soling, and construction progress (in the development phase of the solar farm). Furthermore, the system 660 may be in communication with an AI processing system 662 to process images and/or metadata 663 produced by the system 660 using AI/ML-based data processing and analytics, visualization, anomaly detect, and so on.

The work & asset management function 618 may further include a centralized data historian 664, which may be a data repository that is configured to store data the process data 640 produced by the systems 630. A data extraction system 666 may be configured to collect the process data 640 via a data integration layer 668 as stored in the centralized data historian 664, and process and communicate process data 667 to the AI processing system 662. The AI processing system 662 may utilize the various data to generate an energy generation forecast 669 to a user interface system 670, such as POWERSuite, that is primarily configured to support the energy sector. For example, the AI processing system 662 may process the process data 667 to determine current operations (e.g., real-time energy production and equipment operational data) as part of the AI processing. The AI processing system 662 may utilize one or more processors to execute AI/ML processing, such as executing one or more neural networks and machine learning algorithms in processing the disparate data (e.g., images and metadata 663, process data 667, fault data from the anomaly detection function 624, notification, alarms, visualization 626, and generation forecasting 628). Resulting from the AI processing system 662, the auto generated work orders 661 may provide an operator of the integrated energy production system 600 with the ability to safely and effectively optimize energy production given the scale of such a system 600. The integrated system 600 may be a solar farm or other large-scale energy production (e.g., wind energy). The processor may automatically determine underperformance of the energy production system 600, automatically analyze data captured from the selected inspection system, determine whether or not to perform a remedial action to increase energy production by the energy production equipment, and deploy the remedial action to be performed. It should be understood that the processors for performing the AI/ML operations of the AI processing system 662 may also be considered processors that execute the process data extractor 666, for example. Using the integrated system 600, an end-to-end system provides for the ability to optimize an energy production system, such as a solar farm.

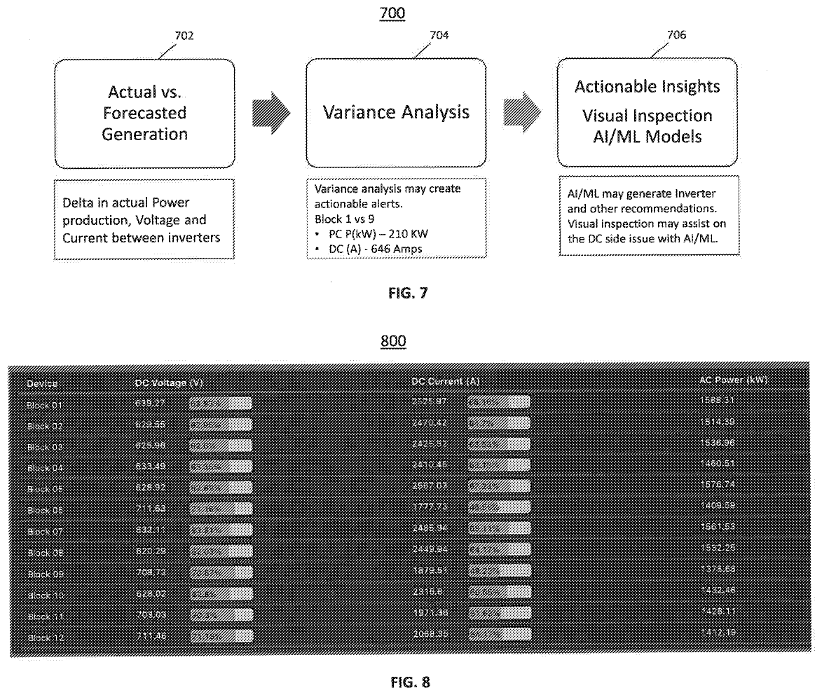

With regard to FIG. 7, an illustration of an illustrative high-level process 700 for analyzing collected information from a solar farm or any other energy production site is shown. The process 700 may start at step 702, where actual versus forecasted energy generation is performed. In making the comparison, a delta in actual power production may be made by comparing voltage and current produced by inverters on the solar farm. The inverters are common electrical components (i.e., equipment with the same specifications) that are parallel with one another along parallel energy production equipment on a solar farm. As the inverters are common, comparisons may be made between each of the inverters (see FIG. 8, for example). It should be understood that comparisons may be made for other common electrical components, such as combiners (see FIG. 3).

At step 704, a variance analysis may be made. The variance analysis may be configured to create actionable alerts when a comparison between energy production of two inverters results in a variance that crosses a variance threshold. For example, if a variance is significant (e.g., over a certain percentage or specific number of Watts or Amps), an alert may be generated and communicated to initiate an action. At step 706, actionable insights may be taken in response to an actionable alert is received. The actionable insights may initiate a visual inspection that utilizes AI/ML models, where the AI/ML insights may identify potential or actual problems and generate inverter and other recommendations for remedial action. Visual inspection assists on the DC side issue by using the AI/ML to identify problems, such as shadows, incorrect angles, or otherwise, as previously described.

With regard to FIG. 8, an illustration of an illustrative listing of energy data 800 being monitored from common electrical devices (e.g., inverters) of a solar farm to show relative performance thereof is shown. The listing 800 may include device identifiers (e.g., inverters of each of respective solar farm blocks), DC voltages, DC currents, and AC power being produced by the respective common electrical devices. In addition to the actual DC voltages and currents being displayed, efficiencies of the common electrical devices may be shown. An AI/ML system may monitor the power produced by the electrical devices using a various analysis (e.g., variance analysis 704 of FIG. 7) to identify inefficient electrical devices, thereby allowing the monitoring system and system operator to optimize production of the energy production system.

One embodiment of a computer-implemented method of optimizing energy produced by an energy production site may include receiving, by a processor from an energy sensing system deployed at the energy production site, data indicative of real-time dynamic energy production of energy production equipment at the energy production site. A set of forecasts related to the energy produced by the energy production site including at least one of (i) power generation, (ii) market price, (iii) market demand, and (iv) useful life of the energy production equipment may be generated using a first artificial intelligence engine. Underperformance of the energy production site automatically may be determined by the processor by performing at least one of (i) forecasting energy production, (ii) determining actual versus expected energy production, and (iii) monitoring a common piece of equipment across each of a plurality of parallel branches of common energy production equipment. In response to determining underperformance of the energy production site, an inspection system may be automatically selected from amongst multiple available inspection systems configured to (i) perform inspection of the energy production site and (ii) generate data captured at the energy production site. The data captured from the selected inspection system automatically may be analyzed by the processor to produce inspection analysis data. A determination may be made by the processor as to whether or not to perform a remedial action to increase energy production by the energy production equipment at the energy production site by executing an optimization engine that utilizes a function of the (i) set of forecasts, (ii) inspection analysis data, and (iii) one or more current and forecasted environmental factors at the energy production site. Based on results of the optimization engine, the remedial action may be deployed to be performed at the energy production site if a determination to perform remedial action is made.

Selecting an inspection system may include selecting a visual inspection. Receiving data indicative of real-time dynamic energy production may include receiving data indicative of solar power generated energy. Automatically selecting an inspection system may include automatically selecting a drone configured to fly over a solar farm to capture images of solar panels of the solar farm. Deploying the remedial action may include deploying a solar panel cleaning system. In an alternative embodiment, deploying the remedial action may include deploying an automated mowing system. Deploying the remedial action may include generating a control signal to alter at least one of the common pieces of equipment.

Automatically analyzing, by the processor, the data captured from the selected inspection system to produce inspection analysis data may include executing, by the processor, an artificial intelligence engine to automatically identify abnormalities captured in images or videos by the selected inspection system. Automatically identifying abnormalities may include identifying at least one of (i) cracks on a solar panel, (ii) hotspots on a solar panel, or (iii) shadows on a solar panel.

Utilizing the principles described herein, yield optimization may result, thus reducing downtime and reduced operations and management cost. The solution provided herein supports predictive and real-time capabilities to identify any emerging or escalating issues. Based on the identified issues, actionable intelligence and recommendation may be generated to address the issues based on weather and market price/demand. It is predicted that the full potential of the platform described herein may provide 8-10% of incremental value, and the estimated value creation may be between $12-18M/GW/year. Moreover, the platform provides for a complete life cycle on new solar development from site identification to operations. The platform additionally provides capabilities for speed, reliability, and transparency on construction progress tracking including early risk identification and mitigation.

As used herein, “or” includes any and all combinations of one or more of the associated listed items in both, the conjunctive and disjunctive senses. Any intended descriptions of the “exclusive-or” relationship will be specifically called out.

As used herein, the term “configured” refers to a structural arrangement such as size, shape, material composition, physical construction, logical construction (e.g., programming, operational parameter setting) or other operative arrangement of at least one structure and at least one apparatus facilitating the operation thereof in a defined way (e.g., to carry out a specific function or set of functions).

As used herein, the phrases “coupled to” or “coupled with” refer to structures operatively connected with each other, such as connected through a direct connection or through an indirect connection (e.g., via another structure or component).

The previous description is of various preferred embodiments for implementing the disclosure, and the scope of the invention should not necessarily be limited by this description. The scope of the present invention is instead defined by the claims.

What is claimed:

1. A computer-implemented method of optimizing energy produced by an energy production site, said method comprising:
receiving, by at least one processor from an energy sensing system deployed at the energy production site, data indicative of real-time dynamic energy production of energy production equipment at the energy production site;
generating, using a first artificial intelligence engine, a set of forecasts related to the energy produced by the energy production site including at least one of (i) power generation, (ii) market price, (iii) market demand, and (iv) useful life of the energy production equipment;
automatically determining, by the at least one processor, underperformance of the energy production site by performing at least one of (i) forecasting energy production, (ii) determining actual versus expected energy production, and (iii) monitoring a common piece of equipment across each of a plurality of parallel branches of common energy production equipment;
in response to determining underperformance of the energy production site, automatically selecting an inspection system from amongst a plurality of available inspection systems configured to (i) perform inspection of the energy production site and (ii) generate data captured at the energy production site;
automatically analyzing, by the at least one processor, the data captured from the selected inspection system to produce inspection analysis data;
determining, by the at least one processor, whether or not to perform a remedial action to increase energy production by the energy production equipment at the energy production site by executing an optimization engine that utilizes a function of the (i) set of forecasts, (ii) inspection analysis data, and (iii) one or more current and forecasted environmental factors at the energy production site; and
deploying, based on results of the optimization engine, the remedial action to be performed at the energy production site if a determination to perform remedial action is made.

2. The method according to claim 1, wherein selecting an inspection system includes selecting a visual inspection.

3. The method according to claim 1, wherein receiving data indicative of real-time dynamic energy production includes receiving data indicative of solar power generated energy.

4. The method according to claim 3, wherein automatically selecting an inspection system includes automatically selecting a drone configured to fly over a solar farm to capture images of solar panels of the solar farm.

5. The method according to claim 1, wherein deploying the remedial action includes deploying a solar panel cleaning system.

6. The method according to claim 1, wherein deploying the remedial action includes deploying an automated mowing system.

7. The method according to claim 1, wherein deploying the remedial action includes generating a control signal to alter at least one of the common pieces of equipment.

8. The method according to claim 7, wherein deploying the remedial action includes generating a control signal to alter an inverter.

9. The method according to claim 1, wherein automatically analyzing, by the at least one processor, the data captured from the selected inspection system to produce inspection analysis data includes executing, by the at least one processor, an artificial intelligence engine to automatically identify abnormalities captured in images or videos by the selected inspection system.

10. The method according to claim 9, wherein automatically identifying abnormalities includes identifying at least one of (i) cracks on a solar panel, (ii) hotspots on a solar panel, or (iii) shadows on a solar panel.

11. A system for optimizing energy produced by an energy production site, said system comprising:
a non-transitory memory configured to store information associated with the energy production site;
at least one processor in communication with the non-transitory memory, and configured to:
receive data indicative of real-time dynamic energy production of energy production equipment at the energy production site from at least one energy sensing device deployed at the energy production site;
execute a first artificial intelligence engine to generate a set of forecasts related to the energy produced by the energy production site, the set of forecasts including at least one of (i) power generation, (ii) market price, (iii) market demand, and (iv) useful life of the energy production equipment;
automatically determine underperformance of the energy production site by performing at least one of (i) forecasting energy production, (ii) determining actual versus expected energy production, and (iii) monitoring a common piece of equipment across each of a plurality of parallel branches of common energy production equipment;
in response to determining underperformance of the energy production site, automatically select an inspection system from amongst a plurality of available inspection systems configured to (i) perform inspection of the energy production site and (ii) generate data captured at the energy production site;
automatically analyze the data captured from the selected inspection system received and stored in the non-transitory memory to produce inspection analysis data;
execute an optimization engine that utilizes a function of the (i) set of forecasts, (ii) inspection analysis data, and (iii) one or more current and forecasted environmental factors at the energy production site to produce optimization data indicative of resulting energy production by performing available remedial actions;
determine, based on the optimization data, whether or not to perform a remedial action to increase energy production by the energy production equipment at the energy production site; and
deploy, based on results of the optimization engine, the remedial action to be performed at the energy production site if a determination to perform remedial action is made.

12. The system according to claim 11, wherein the at least one processor, in selecting an inspection system, is configured to select a visual inspection.

13. The system according to claim 11, wherein the at least one processor, in receiving data indicative of real-time dynamic energy production, includes receiving data indicative of solar power generated energy.

14. The system according to claim 13, wherein the at least one processor, in automatically selecting an inspection system, includes automatically selecting a drone configured to fly over a solar farm to capture images of solar panels of the solar farm.

15. The system according to claim 11, wherein the at least one processor, in deploying the remedial action, includes communicating a message to deploy a solar panel cleaning system.

16. The system according to claim 11, wherein the at least one processor, in deploying the remedial action, includes communicating a message to deploy an automated mowing system.

17. The system according to claim 11, wherein the at least one processor, in deploying the remedial action, is further configured to:
generate a control signal to alter at least one of the common pieces of equipment; and
communicate the control signal to the at least one of the common pieces of equipment.

18. The system according to claim 11, wherein the at least one processor, in automatically analyzing, the data captured from the selected inspection system to produce inspection analysis data, is configured to execute an artificial intelligence engine to automatically identify abnormalities captured in images or videos by the selected inspection system.

19. The system according to claim 18, wherein the at least one processor, in automatically identifying abnormalities, is configured to identify at least one of (i) cracks on a solar panel, (ii) hotspots on a solar panel, or (iii) shadows on a solar panel.

20. A computer-implemented method of optimizing energy produced by an energy production site, said method comprising:
receiving, by at least one processor from an energy sensing system deployed at the energy production site, data indicative of real-time dynamic energy production of energy production equipment at the energy production site;
generating, using a first artificial intelligence engine, a set of forecasts related to the energy produced by the energy production site;
automatically determining, by the at least one processor, underperformance of the energy production site;
in response to determining underperformance of the energy production site, automatically selecting an inspection system from amongst a plurality of available inspection systems configured to (i) perform inspection of the energy production site and (ii) generate data captured at the energy production site;
automatically analyzing, by the at least one processor, the data captured from the selected inspection system to produce inspection analysis data;
determining, by the at least one processor, whether or not to perform a remedial action to increase energy production by the energy production equipment at the energy production site by executing an optimization engine that utilizes a function of the (i) set of forecasts, (ii) inspection analysis data, and (iii) one or more current and forecasted environmental factors at the energy production site; and
deploying, based on results of the optimization engine, the remedial action to be performed at the energy production site if a determination to perform remedial action is made.
